(19) United States
(12) Patent Application Publication
(10) Pub. No.: US 2014/0272763 A1
(43) Pub. Date: Sep. 18, 2014

(54) SHADE GUIDE KIT FOR MATCHING DENTAL COMPOSITES TO A PERSON'S TEETH

(71) Applicant: UItradent Products, Inc., South Jordan, UT (US)

(72) Inventor: Neil T. JESSOP, Sandy, UT (US)

(73) Assignee: UItradent Products, Inc., South Jordan, UT (US)

(21) Appl. No.: 14/191,138

(22) Filed: Feb. 26, 2014

Related U.S. Application Data
(60) Provisional application No. 61/789,198, filed on Mar. 15, 2013.

(51) Int. Cl. A61C 19/10

(52) U.S. Cl. CPC A61C 19/10
USPC 433/26

(57) ABSTRACT

Dental shade guide systems include an elongate holder with a plurality of receptacles for holding a plurality of shade guide sticks, and a plurality of shade guide sticks. Each shade guide stick may include an elongate dentin body portion comprising a dental composite that is relatively opaque so as to be representative of dentin, and an enamel head portion at an end of the elongate dentin body portion, the enamel head portion comprising an outer layer of a dental composite that is relatively translucent so as to be representative of enamel, the outer layer overlaying the dentin body portion at the enamel head portion end of the stick.

### CROSS-REFERENCE TO RELATED APPLICATIONS

The present application claims the benefit of U.S. Patent Application Ser. No. 61/789,198, filed Mar. 15, 2013, entitled “SHADE GUIDE KIT FOR MATCHING DENTAL COMPOSITES TO A PERSON'S TEETH”, the disclosure of which is incorporated by reference in its entirety.

### BACKGROUND

1. The Field of the Invention

The present invention is in the field of systems for use in providing desired shade matching between a dental appliance (e.g., crowns, bridges, veneers, etc.) and adjacent natural teeth and/or adjacent dental appliances.

2. The Relevant Technology

Dental appliances are typically prepared by a dental practitioner or trained dental technician. Often, the preparation of any such appliance is an elaborate multi-step process, sometimes fulfilled by a separate dental lab specializing in custom appliance fabrication. One recurring difficulty in dental appliance preparation, whether performed by the patient's own dental practitioner or a third party, is achieving consistent shade matching between the appliance and adjacent dental structure, whether such structure is natural tooth tissue or another dental prosthetic appliance.

For example, the occlusal edge of a natural tooth is typically at least somewhat translucent to visible light because of the light transmission characteristics of tooth enamel, while the more central portions of the tooth are typically relatively more opaque due to the presence of underlying tooth dentin and/or pulp located within the interior of the tooth beneath the enamel. In addition, most teeth are not naturally bright white, but rather include some natural color shading. In addition, from one patient to another, and even from one tooth to another of the same patient, enamel and dentin often vary in specific visual ways relative to color and/or degree of opacity or translucency. Given the complexity of matching such visual characteristics, consistency in achieving a high level of shade matching can be elusive for many practitioners. It would be an advance in the art to provide a system that would aid a practitioner, particularly those who with less experience and/or skill in this artistic practice, with the ability to more consistently achieve shade matching for a dental appliance relative to adjacent natural and/or prosthetic dental structures.

### BRIEF SUMMARY

Disclosed herein are dental shade guide systems comprising an elongate holder with a plurality of receptacles for holding a plurality of shade guide sticks, and a plurality of shade guide sticks. Each shade guide stick may include an elongate dentin body portion comprising a dental composite that is relatively opaque so as to be representative of dentin, and a head portion overlaying an end of the elongate dentin body portion and that is representative of enamel. The enamel head portion forms an outer layer of dental composite that is more translucent and less opaque than the dentin body portion so as to be representative of enamel.

According to one example embodiment, a plurality of shade guide sticks includes a first set of sticks and second set of sticks. The first set includes substantially identically colored dentin body portions and differently colored enamel head portions. The second set of sticks includes differently colored dentin body portions and substantially identically colored enamel head portions.

In another aspect of the disclosure is a dental shade guide system comprising a plurality of shade guide sticks and an elongate holder formed of an elastomeric transparent or translucent material including a plurality of transverse receptacles extending cross-wise through the elongate holder for holding the plurality of shade guide sticks. Each shade guide stick may include an elongate dentin body portion comprising a dental composite that is relatively opaque so as to be representative of dentin, and a head portion overlaying an end of the elongate dentin body portion and that is representative of enamel. The enamel head portion forms an outer layer of dental composite that is more translucent and less opaque than the dentin body portion so as to be representative of enamel.

The dental shade guide systems provide accurate visual representations of a large number of different dentin dental composite and enamel dental composite combinations. This allows the practitioner to use the shade guide sticks to easily identify a potential match for an adjacent natural or prosthetic tooth. In addition to aiding in providing accurate matches to both dentin representative dental composites and enamel representative dental composites, the shade guide sticks are advantageously formed of a dental composite themselves. This is very helpful as the actual shade provided in a finished product may depend to some degree on the substance from which it is formed (e.g., one or more dental composites). In other words, a color printed or otherwise provided in a substrate such as paper that differs from the substrate employed in the finished product often alters the perceived color shade characteristics so that something that may appear to be a good match may actually not be.

The shade guide sticks and holder may facilitate holding of the various shade guide sticks (which are formed of dental composite) in a manner where the practitioner may easily and quickly see both the enamel head portion and the opposite dentin body portion of any desired shade guide stick. For example, the holder can be transparent to allow visual inspection of sticks held within respective receptacles. In addition, the holder may be such that the shaft of the dentin body portion may extend below the receptacle so as to be visible in that way. Another embodiment of the holder may include one or more window portions through which the sticks are visible to the practitioner to aid in finding a color match to both dentin and enamel characteristics, without having to remove a stick.

These and other benefits, advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary dental shade guide system including a holder and a plurality of shade guide sticks received therein;

FIG. 2A is a perspective view of the holder of the system of FIG. 1 with the sticks removed;

FIG. 2B is a perspective view of an alternative holder;

FIG. 2C is a perspective view of yet another alternative holder;

FIG. 3A is a perspective elevation view of a shade guide stick of the system of FIG. 1;

FIG. 3B is a longitudinal cross-sectional view through the shade guide stick of FIG. 3A; and

FIG. 4 schematically illustrates a plurality of shade guide sticks including first and second shade guide sticks: a first set in which the dentin body portions are identically colored and the enamel head portions differ from one to another; and a second set that includes identically colored enamel head portions with differently-colored dentin body portions.

### DETAILED DESCRIPTION

### I. Introduction

Disclosed herein are shade guide systems for use in aiding a practitioner in matching a composite restorative (e.g., a crown, veneer, filling, or other dental restorative) to the coloring of a patient's adjacent natural or prosthetic tooth material. The system includes an elongate holder comprising a plurality of receptacles (e.g., formed cross-wise through the holder). Each receptacle may be capable of receiving a shade guide stick therein. Example shade guide systems further include a plurality of shade guide sticks.

The shade guide sticks may be formed of the same or similar dental composites as the dental prosthetic or other restorative to be shade matched. Each shade guide stick may include an elongate dentin body portion comprising a dental composite that is representative of dentin. Such a dental composite may be relatively opaque and may include a colorant or dye incorporated therein. Each shade guide may further include an enamel head portion disposed at an end of the elongate dentin body portion. The enamel head portion comprises an outer layer of another dental composite that is less opaque and more translucent so as to be representative of enamel laid over the dental composite of the dentin body portion. Thus, the enamel head portion includes at least two different composite layers, while the dentin body portion may include a single homogenously colored layer. The dental composite of the outer layer of the enamel head portion may be translucent, similar to natural enamel, allowing some of the coloring of the underlying dentin body portion to show through. As a result of this configuration, the shade guide stick includes different portions (i.e., a dentin portion and an enamel portion) that are closely representative of different portions of the natural tooth (and particularly the prosthetic or other restorative being made), and which can be used by the practitioner to select a close match for the restorative to be installed.

When inserted into a receptacle of the holder, the enamel head portion of a shade guide stick may remain above an upper edge of the holder, while the elongate dentin body portion (e.g., in the form of a shaft) of the stick can be received into the receptacle. Thus, the enamel head portion may be readily visible to the practitioner even when the shade guide stick received in the holder. In one embodiment, the holder may be transparent or translucent so as to allow a practitioner to visually examine even that portion of a given shade guide stick that is received within a receptacle of the holder. Alternatively, the holder may include cut-out notches at an end of each receptacle, allowing an end of the dentin body portion to extend beyond an end of the receptacle so as to be viewed in that manner. Another embodiment may include one or more window portions in the holder through which at least a portion of the received dentin body portion may be viewed.

### II. Exemplary Shade Guide Systems

FIG. 1 illustrates an exemplary dental shade guide system 100. System 100 includes an elongate holder 102. A plurality of receptacles 104 may be formed through the body of holder 102. In the illustrated configuration, receptacles 104 extend cross-wise through holder 102 so as to be generally perpendicular relative to a longitudinal axis -A- of holder 102. Although illustrated as being oriented generally perpendicular relative to axis -A-, it will be appreciated that in other embodiments, slot-shaped receptacles 104 may be differently configured. For example, they may be oriented to be transverse to longitudinal axis -A- at some angle other than about 90° (e.g., they could be angled at other angles such as about 45°, 60°, 70°, 80°, etc.).

As seen in FIG. 1, a plurality a shade guide sticks 106 are received within receptacles 104, one stick 106 per receptacle 104. Sticks 106 may be held in place by friction fit to prevent them from falling out if holder 102 is turned upside down (i.e., with the crown shaped heads 108 of sticks 106 pointing downward). According to one embodiment, shade guide sticks 106 may be identically shaped relative to one another. The receptacles may likewise be identically shaped relative to one another so as to allow any given shade guide stick 106 to be inserted into any given receptacle 104. As seen, when inserted, the enamel head portion 108 may extend above upper edge 110 of holder 102 so that head portions 108 are directly visible. A central portion of elongate dentin shaft-shaped body portion 112 may be received within receptacle 104, while an end of dentin body portion 112 extends beyond receptacle 104, as seen. In this way, at least a portion of elongate dentin body portion 112 can be visible to a practitioner for visual examination and comparison for color matching, even when shade guide stick 106 is held within holder 102.

FIG. 2A shows holder 102 without any shade guide sticks 106 received within receptacles 104, so as to better illustrate the configuration of receptacles 104. As shown, holder 102 may include inverted U-shaped, inverted V-shaped, or similar recessed notches 114 formed in holder 102 opposite upper edge 110. Notches 114 may be aligned with receptacles 104, effectively shortening the length of each receptacle 104. This allows an end portion of dentin body portion 112 of stick 106 inserted into receptacle 104 to extend beyond the end of receptacle 104, into notch 114, so that the portion of stick 106 in notch 114 is exposed and directly visible to the practitioner.

Holder 102 may be formed of any suitable material. In several embodiments, it may be formed of a polymeric plastic material. In one embodiment, the holder may comprise an elastomeric material, such as silicone or a thermoplastic elastomer (TPE). Such materials may provide holder 102 with a high degree of flexibility. In an embodiment, the material from which holder 102 is formed may be transparent or translucent (e.g., a transparent silicone or transparent TPE material). Transparency or translucency allows a practitioner to see through holder 102, permitting viewing of those portions of any given stick 106 that are otherwise received within holder 102. In another embodiment, a portion of holder 102 may be formed of such a transparent or translucent material, effectively providing one or more window portions for indirect viewing (through holder 102) of the shade guide sticks 106. In such an embodiment, some portion of holder 102 could be opaque.

Although holder 102 is shown in a configuration in which receptacles 104 are open at both the top (e.g., adjacent enamel head portion 108) and bottom (e.g., adjacent notch 114), it will be appreciated that other configurations are possible. For example, an alternative receptacle 104′ may be open at top and closed at the bottom as shown in FIG. 2B. In another embodiment, the receptacles may be open along a front or back side, forming a plurality of 3-walled slots or receptacles 104″, as shown in FIG. 2C. Such a configuration may allow a user to press a stick 106 transversely into receptacle 104, without requiring insertion in a line of motion that follows the longitudinal axis of the receptacle. In other words, one may simply press a stick into a receptacle from an open front or back side of receptacle 104″, rather than having to insert stick 106 from the top downward, as in FIGS. 2A-2B.

In embodiments including an open front or back side (e.g., FIG. 2C), forming holder 102 of an elastomeric material may be particularly helpful. This permits the walls defining receptacles 104″ to be flexible and elastomeric so as to easily grip an inserted stick in a friction fit. Where desired, a keyed retaining mechanism may also be provided (e.g., providing each stick with a longitudinal groove 107 formed on each side, with corresponding keyed protrusions 109 extending from opposing side walls (or a back or front wall) of receptacle 104″ open on the front or back side and walled on 3 remaining sides. Where holder 102 is formed of an elastomeric material, such keyed protrusions 109 could readily deform and spring into place within longitudinal grooves 107 of stick 106s, holding them in place.

FIGS. 3A and 3B illustrate an exemplary shade guide stick 106 in additional detail. Shade guide stick 106 may be configured to include at least two differently configured regions, each formed of dental composite. Forming shade guide stick 106 of dental composite aids the practitioner in better matching a proposed restoration or prosthetic with the natural teeth (or prosthetics) adjacent to where the restoration is to be installed, as the shade guide stick may advantageously be formed of the same or similar dental composite material(s) from which the restoration or prosthetic is to be formed. This is helpful because a color shade illustrated by a different type of material (i.e., color(s) on paper or cardboard) may sometimes appear to be a good match, but once the final product is installed, the color shade may not match as closely as thought at the time the matching was done, due to effects of the substrate material on shade perception. Forming the shade guide from the same or similar substrate materials (e.g., cured dental composites) as the final restoration structure to be installed reduces or eliminates variance caused by the substrate on the perceived shade.

Shade guide stick 106 may include an elongate dentin body portion 112 and an enamel head portion 108, each of which may be formed of a dental composite material. Dentin body portion 112 may be formed of a dental composite material that is relatively opaque (e.g., it may include an opacifying component) so that body portion 112 of stick 106 is visually opaque. Dyes or pigments may be incorporated into the dental composite material from which dentin body portion 112 is formed to provide it with one of a variety of color shades representative of dentin.

Shade guide stick 106 further includes an enamel head portion 108 (e.g., which may be shaped to resemble the crown portion of a tooth, e.g., incisor or cuspid) at an end of stick 106. Dentin body portion 112 may extend substantially along an entire length of stick 106 (FIG. 3B), while an outer layer 116 of another dental composite, this one representing enamel, can be overlaid over an end of the dentin body portion dental composite at enamel head portion 108. The dental composite of outer layer 116 may differ from the dental composite of dentin body portion 112 in that outer layer 116 may be more translucent and less opaque so as to resemble natural enamel.

For example, with regard to enamel, materials used to replace missing enamel are typically semi-translucent milky white tints of varying opacity, translucency, and chroma. To be representative of enamel, outer layer 116 may typically include some degree of translucency (e.g., as compared to the dentin body portion, which will typically have a higher degree of opacity). The dental composite used in forming outer layer 116 is formed of such a material. In this way, as seen in FIG. 3B, the enamel head portion 108 can include two distinct regions: a dentin body portion 112 region with an overlaid outer layer 116 region that is representative of enamel. As such, enamel head portion 108 mimics the anatomy of a natural tooth, including an outer layer of more translucent enamel provided over an underlying layer of less translucent and more opaque dentin tooth material.

As seen in FIGS. 3A and 3B, the distal end of stick 106 may be tapered and/or rounded to facilitate easier insertion into receptacle 104 of holder 102.

Indicia may be provided on stick 106 indicating the color shade characteristics represented by its enamel head portion 108 and its dentin body portion 112. For example, such indicia may refer to the VITA shade guide or any other appropriate color identification system. By way of background or example, the VITA shade identification system may contain 4 basic color groups (identified as A, B, C, and D) and several degrees of intensity within each basic color group for a total of 16 color shade/intensity designations. In this system, the color group A designates red-brown and includes intensities A1, A2, A3, A3.5, and A4. Color group B designates red-yellow and includes intensities B1, B2, B3, and B4. Color group C designates gray and includes intensities C1, C2, C3, and C4. Color group D designates reddish gray and includes intensities D2, D3, and D4. The lower the number is in any given color group, the less intense the color. In other words, an A2 shade is a more intense red-brown than an A1 shade. It will be understood that other systems may be used with the present shade guide systems.

Any suitable dental composite materials may be employed in manufacturing shade guide sticks as disclosed herein, including exemplary shade guide stick 106. In one embodiment, the same or similar dental composite materials employed in restorative prosthetic manufacture can be employed. For example, the dental composites of dentin body portion 112 and outer layer 116 of enamel head portion 108 may comprise typical light curable composite materials that are used in tooth restorations within the oral cavity.

Exemplary composites may typically include a base resin material, optionally a filler, optionally one or more pigments or dyes, and a photoinitiator or other curing system. Exemplary base resin materials include, but are not limited to, bisphenol A diglycidyl dimethacrylate (Bis-GMA), triethyleneglycol dimethacrylate (TEG-DMA), urethane dimethacrylate (UDMA), glycidyl methacrylate (GMA), 2-hydroxyethyl methacrylate (HEMA) and/or ethoxylated bisphenol A dimethacrylate (Bis-EMA). Such resin materials may be phosphated, as desired.

Fillers typically employed in such dental composites include reinforcing glass or ceramic fibrous fillers or particulate fillers. Pigments may also be included within one or both dentin portion 112 and enamel outer layer 116. Often the dentin body portion 112 may include more coloration than translucent outer layer 116, which may include little or no pigment. Exemplary pigments include iron oxide, titanium dioxide, food grade colorants or pigments, or combinations thereof.

Exemplary photoinitiators include, but are not limited to, camphorquinone, phenolpropanedione, and IRGACURE, sold by Ciba Specialty Chemicals, of Basel, Switzerland. Other curing systems (e.g., chemical cure systems such as peroxide and amine based systems) may be incorporated into the dental composites where the composites are cured by a technique other than light curing.

As shown in FIG. 4, the plurality of shade guide sticks 106 may include a first set 118 of sticks 106 in which a dentin body portion 112 of each stick in first set 118 is representative of the same dentin color, while enamel head portions 108 differ from each other in color. A second set 120 of sticks 106 is configured differently, wherein each enamel head portion 108 of each stick 106 of second set 120 is representative of the same enamel color, while dentin body portions 112 differ from each another in color. Such a configuration of multiple, differently configured sets provides potential matches for a wide variety of natural tooth colors relative to both dentin color and enamel color, while being organized in an easy to use manner (only one variable is changed within each set, with a different variable being changed within another set).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dental shade guide system comprising:
a holder comprising a plurality of receptacles for holding a plurality of shade guide sticks; and
a plurality of shade guide sticks, each shade guide stick including:
an elongate dentin body portion comprising a dental composite that is opaque so as to be representative of dentin; and
an enamel head portion overlaying an end of the elongate dentin body portion, the enamel head portion comprising an outer layer of another dental composite that is translucent so as to be representative of enamel.

2. A dental shade guide system as recited in claim 1, wherein the holder is formed of a transparent or translucent material.

3. A dental shade guide system as recited in claim 1, wherein the holder is formed of an elastomeric material.

4. A dental shade guide system as recited in claim 1, wherein the elongate dentin body portion of each shade guide stick is receivable into a corresponding receptacle of the holder.

5. A dental shade guide system as recited in claim 1, wherein each of the receptacles extends transversely through the holder relative to a longitudinal axis of the holder so that the receptacles extend cross-wise through the elongate holder.

6. A dental shade guide system as recited in claim 5, wherein the receptacles extend all the way through the holder, and wherein the elongate dentin body portion of each shade guide stick and each corresponding receptacle are sized so that an end of the elongate dentin body portion of each shade guide stick extends beyond an end of a corresponding receptacle when a respective elongate dentin body portion is inserted into the corresponding receptacle.

7. A dental shade guide system as recited in claim 1, wherein the elongate dentin body portion of each shade guide stick is receivable into a corresponding receptacle of the holder, the holder including one or more window portions through which at least a portion of each elongate dentin body portion is visible.

8. A dental shade guide system as recited in claim 1, wherein the enamel head portion of each shade guide stick is shaped as a crown portion of a tooth.

9. A dental shade guide system as recited in claim 1, wherein the shade guide sticks include a first set of sticks and a second set of sticks, the first set of sticks including substantially identically colored dentin body portions and a plurality of differently colored enamel head portions, the second set of sticks including substantially identically colored enamel head portions and a plurality of differently colored dentin body portions.

10. A dental shade guide system comprising:
a plurality of shade guide sticks, each shade guide stick including:
an elongate dentin body portion comprising a dental composite that is opaque so as to be representative of dentin; and
an enamel head portion overlaying an end of the elongate dentin body portion, the enamel head portion comprising an outer layer of another dental composite that is translucent so as to be representative of enamel,
the shade guide sticks further including:
a first set of sticks comprised of substantially identically colored dentin body portions and a plurality of differently colored enamel head portions; and
a second set of sticks comprised of substantially identically colored enamel head portions and a plurality of differently colored dentin body portions.

11. A dental shade guide system as recited in claim 10, wherein the enamel head portion of each shade guide stick is shaped as a crown portion of a tooth.

12. A dental shade guide system as recited in claim 10, further comprising a holder that includes a plurality of receptacles for holding the shade guide sticks;

13. A dental shade guide system as recited in claim 12, wherein the holder is formed of a transparent or translucent material.

14. A dental shade guide system as recited in claim 12, wherein the holder is formed of an elastomeric material.

15. A dental shade guide system as recited in claim 12, wherein the elongate dentin body portion of each shade guide stick is receivable into a corresponding receptacle of the holder.

16. A dental shade guide system as recited in claim 15, wherein the receptacles of the holder are configured so that, when the shade guides sticks are inserted into corresponding receptacles, at least a portion of the dentin body portion of a shade stick is visible to a user.

17. A dental shade guide system comprising:
a holder formed of an elastomeric transparent or translucent material comprising a plurality of transverse receptacles extending cross-wise through the holder for holding a plurality of shade guide sticks; and
a plurality of shade guide sticks, each shade guide stick including:
an elongate dentin body portion comprising a dental composite that is opaque so as to be representative of dentin; and
an enamel head portion overlaying an end of the elongate dentin body portion, the enamel head portion comprising an outer layer of another dental composite that is translucent so as to be representative of enamel.

18. A dental shade guide system as recited in claim 17, wherein the elongate dentin body portion of each shade guide stick is receivable into a corresponding receptacle of the holder.

19. A dental shade guide system as recited in claim 17, wherein each of the receptacles extends transversely through the holder relative to a longitudinal axis of the holder so that the receptacles extend cross-wise through the elongate holder.

20. A dental shade guide system as recited in claim 18, wherein the elongate dentin body portion of each shade guide stick and each corresponding receptacle are sized so that an end of the elongate dentin body portion of a shade guide stick extends beyond an end of a corresponding receptacle when a respective elongate dentin body portion is inserted into the corresponding receptacle.

21. A dental shade guide system as recited in claim 20, wherein the holder further comprises a plurality of notches, each notch being aligned with a distal end of each receptacle so that the end of the elongate dentin body portion of the shade guide stick extending beyond an end of the corresponding receptacle is disposed within a corresponding notch.
